(19) United States
(12) Patent Application Publication
(10) Pub. No.: US 2003/0236022 A1
(43) Pub. Date: Dec. 25, 2003

(54) Apparatus for indicating a terminal insertion position

(75) Inventors: Atsuo Nakamura, Yokkaichi-city (JP); Hisato Chujo, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 10/422,991

(22) Filed: Apr. 25, 2003

(30) Foreign Application Priority Data
Apr. 26, 2002 (JP) 2002-127510

(51) Int. Cl. H01R 3/00

(52) U.S. Cl. 439/488

(57) ABSTRACT

An apparatus for indicating a terminal insertion position includes an indicating bar. The indicating bar can be moved in the X and Y-directions with respect to a housing holder by a driving mechanism. In order to indicate a target cavity in a connector housing contained in the housing holder, the indicating bar is moved to a position corresponding to the target cavity along a coordinate on the X-axis and moved to a position approaching the Y-axis. If another terminal has been already inserted into a cavity near the target cavity, the indicating bar is moved to a coordinate on the Y-axis where the terminal does not interfere with the indicating bar. An indicator lights up to specify a coordinate of the cavity on the Y-axis.

### BACKGROUND OF THE INVENTION

1. Field of the Invention

This invention relates to an apparatus for indicating a terminal insertion position.

2. Description of Related Art

In general, a wire harness is an electric wiring system that forms a predetermined network by connecting a plurality of electric wires to connectors.

Upon producing such a wire harness, it is necessary to connect electric wires having terminals attached thereto to cavities in connectors to form circuits. This operation requires connecting a specified electric wire having a terminal to each cavity in each connector.

However, it is difficult to connect the specified electric wires having terminals to each cavity. In the case of performing this work manually, it is necessary to provide a mechanism to assist in indicating an inserting order. Such a mechanism generally adopts a method in which an indicator displays an artificial arrangement of cavities so that a lamp corresponding to an insertion objective cavity is lit up (referred to as a “lamp method”) or a physical method in which an indicating means indicates an insertion objective cavity directly (referred to as an “indicating method”).

However, since the indicator is spaced from the worker's hands in the lamp method, errors will occur on account of a false perception of a worker. On the other hand, it is difficult to indicate an insertion objective cavity in the indicating method, if another terminal has been already inserted into a cavity near the insertion objective cavity.

### SUMMARY OF THE INVENTION

In view of the above problems, an object of the present invention is to provide an apparatus for indicating a terminal insertion position that can efficiently indicate an insertion objective cavity and prevent human error.

In order to solve the above problem, the present invention is directed to an apparatus for indicating a terminal insertion position wherein, when a terminal of an electric wire is inserted into a corresponding cavity out of plural cavities that can be specified by intersected two-dimensional coordinates to produce a wire harness, a target cavity to receive the terminal is successively indicated to a worker. The apparatus includes a housing holder for holding a connector housing with a terminal able to be inserted into the cavity; an indicating bar disposed in the apparatus to move with respect to the housing holder and extending along one of the coordinates of the cavity in the housing contained in the housing holder; an indicator disposed on the indicating bar for indicating the other coordinate of the cavity indicated by the indicating bar; a driving mechanism for driving the indicating bar; and a controlling means for controlling the driving mechanism and the indicator so that the indicating bar moves to a position opposed to the one coordinate of the cavity with the indicating bar avoiding interference with an electric wire with terminals that has been inserted and the indicator displays the other coordinate of an insertion objective cavity.

In the present invention, when an electric wire with terminals is manually inserted into a corresponding cavity, since the indicating bar moves to a position opposed to one of the coordinates of the insertion objective cavity to indicate the one coordinate, it is possible to indicate a target to a worker in the vicinity of the objective cavity. Accordingly, it is possible to prevent an insertion error. On the other hand, since the present invention adopts the indicator provided on the indicating bar as means for indicating the other coordinate of the insertion objective cavity, it is possible to indicate both coordinates of the insertion objective cavity while the other cavities are open and to indicate an insertion target of a terminal without interference with the electric wire with terminals, the terminal of which has been already inserted into the cavity. Consequently, even if any cavity out of plural cavities is indicated at random, a worker can proceed with an inserting work of terminals without any difficulty. Accordingly, even if a kind of an objective wire harness to be produced is changed, it is possible to alter a setting of the controlling means without any restriction upon a change of specification.

According to another aspect of the present invention, the housing holder in the apparatus includes a housing-positioning hole for containing the housing; a regulating member provided on the housing holder for opening and closing the housing-positioning hole with the cavity in the housing held in the housing-positioning hole being open; and a driving member for displacing the regulating member between a detachable position where the housing is allowed to be inserted into or to be removed from the housing-positioning hole and a regulating position where the housing is restrained from moving.

According to the present invention, a worker can easily insert the housing into the housing holder by moving the regulating member to the detachable position by the driving member. When the regulating member is moved to the regulating position, the electric wire with terminals can be inserted into the cavity and the regulating member is prevented from movement to a direction releasing the cavity, since the cavity in the housing is open.

Accordingly, a worker can efficiently proceed with an inserting work of an electric wire with terminals.

An aspect of the present invention provides an apparatus for indicating a terminal insertion position in which a terminal of an electric wire is to be inserted into a target cavity of a plurality of cavities in a connector housing, the target cavity specified by intersecting two dimensional coordinates, to produce a wire harness, wherein target cavities to receive respective terminals are successively indicated to an operator, the apparatus including a housing holder configured to hold a connector housing such that a terminal may be inserted into a target cavity, an indicating bar provided in the apparatus to move with respect to the housing holder, the indicating bar extending along one of the coordinates of the target cavity in the housing inserted in the housing holder and indicating the one coordinate of the target cavity, an indicator provided on the indicating bar that indicates the other coordinate of the target cavity indicated by the indicating bar, a driving mechanism that drives the indicating bar; and a controlling device that controls the driving mechanism and the indicator so that the indicating bar moves to a position corresponding to the one coordinate of the target cavity with the indicating bar avoiding interference with an electric wire that has been inserted and the indicator displays the other coordinate of the target cavity.

In a further aspect of the present invention, the housing holder may include a housing positioning hole configured to contain the connector housing; a regulating member provided on the housing holder configured to open and close the housing positioning hole; and a driving member configured to displace the regulating member between an open position in which the connector housing may be inserted into or removed from the housing positioning hole and a closed position in which the connector housing is prevented from being inserted or removed from the housing positioning hole. Further, the housing holder, the indicating bar, and the driving mechanism may be contained within a casing, and the apparatus further includes a housing base provided in the casing, the housing base supporting the housing holder so that the connector housing is held by the housing holder with an end face thereof extending in a longitudinal direction.

In a further aspect of the present invention, the driving mechanism includes a drive screw provided in the casing and extending along the longitudinal direction; a driving block mounted on the drive screw and connected to the indicating bar; and an X-axis motor provided in the casing and connected to the drive screw, wherein the X-axis motor drives the indicating bar, via the drive screw and the driving block, along the longitudinal direction between cavities in the connector housing. Further, the housing base may support a plurality of housing holders next to each other in the longitudinal direction and the X-axis motor drives the indicating bar along the longitudinal direction between connector housings in the housing holders. Further, the driving mechanism may further include a second drive screw provided in the casing and extending along a direction transverse to the longitudinal direction; a driving head mounted on the second drive screw and connected to the indicating bar; and a Y-axis motor provided in the casing and connected to the second drive screw, wherein the Y-axis motor drives the indicating bar, via the second drive screw and the driving head, along the transverse direction between cavities in the connector housing. The indicator may include a lamp or a plurality of lamps corresponding to respective terminal insertion positions in the transverse direction. The housing base may support the housing holder so that the connector housing is held by the housing holder with an end face thereof extending in the longitudinal and the transverse directions so that a terminal may be inserted in a target cavity in a Z-axis direction perpendicular to the X-axis and the Y-axis.

In a further aspect of the present invention, the driving head includes a driving base supported by the second drive screw; a pair of rails provided on the driving base and extending in a Z-axis direction perpendicular to the X-axis and the Y-axis; and a coupling base provided on the indicator, the coupling base configured to slide between the pair of rails, wherein the indicator is movable in the Z-axis direction. The indicator may further include an indicating finger extending from the coupling base. The apparatus may further include an indicating base mounted on the casing; and a lamp provided on the indicating base, the lamp indicating to an operator terminal insertion information. The casing may be provided in an inclined position, facing an operator position. The apparatus may further include a tension testing device including a mounting plate mounted in the casing, the mounting plate including a plurality of through holes therein; a housing holder adaptor configured to receive the housing holder and including a plurality of posts configured to couple with the through holes in the mounting plate so that the housing holder adaptor is movable relative to the mounting plate in a Z-axis direction perpendicular to the X-axis and the Y-axis; and a sensor provided on the mounting plate and a detecting plate mounted on the housing holder adaptor for interaction with the sensor to detect movement in the Z-axis direction between the mounting plate and the housing holder adaptor; wherein when an inserted terminal is pulled in the Z-axis direction the sensor and the detecting plate detect movement between the mounting plate and the housing holder adaptor and the controlling device indicates tension induced by the terminal pulling.

A further aspect of the present invention provides in combination, a wire harness producing system; an electric wire containing unit; a housing containing unit; and an apparatus for indicating a terminal insertion position.

Another aspect of the present invention provides a method of indicating a terminal insertion position in which a terminal of an electric wire is to be inserted into a target cavity of a plurality of cavities in a connector housing, the target cavity specified by intersecting two dimensional coordinates, to produce a wire harness, wherein target cavities to receive respective terminals are successively indicated to an operator, the method including holding a connector housing in a housing holder such that a terminal may be inserted into a target cavity; moving an indicating bar with respect to the housing holder, the indicating bar extending along one of the coordinates of the target cavity in the housing inserted in the housing holder and indicating the one coordinate of the target cavity; indicating the other coordinate of the target cavity with an indicator provided on the indicating bar; driving the indicating bar with a driving mechanism; and controlling the driving mechanism and the indicator so that the indicating bar moves to a position corresponding to the one coordinate of the target cavity with the indicating bar avoiding interference with an electric wire that has been inserted and the indicator displays the other coordinate of the target cavity. The method may further include containing the connector housing in a housing positioning hole in the housing holder, the housing holder including a regulating member configured to open and close the housing positioning hole; and displacing the regulating member with a driving member between an open position in which the connector housing may be inserted into or removed from the housing positioning hole and a closed position in which the connector housing is prevented from being inserted or removed from the housing positioning hole. Further, the method may include containing the housing holder, the indicating bar, and the driving mechanism in a casing; providing a housing base in the casing, the housing base supporting the housing holder so that the connector housing is held by the housing holder with an end face thereof extending in a longitudinal direction; driving the indicating bar along the longitudinal direction between cavities in the connector housing to indicate a target cavity position along the longitudinal direction; and driving the indicating bar along a direction transverse to the longitudinal direction to indicate a target cavity position along the transverse direction. The indicator may include a plurality of lamps, and the method may further include further indicating the target cavity position along the transverse direction via the lamps. Further, the housing base may support the housing holder so that the connector housing is held by the housing holder with an end face thereof extending in the longitudinal and the transverse directions, and the method may further include inserting a terminal in a target cavity in a direction perpendicular to the longitudinal and the transverse directions.

### BRIEF DESCRIPTION OF THE DRAWINGS

The above, and other objects, features and advantages of the present invention will become apparent from the following description of the preferred embodiments, given as nonlimiting examples, with reference to the accompanying drawings in which:

FIG. 1 is a schematic perspective view of a wire harness producing system in an embodiment of the present invention;

FIG. 2 is an enlarged perspective view of a part of an electric wire container unit in the wire harness producing system shown in FIG. 1;

FIG. 3 is a partially enlarged perspective view of an apparatus for indicating a terminal insertion position in the wire harness producing system shown in FIG. 1;

FIG. 4 is a partially enlarged perspective view of the indicating apparatus, illustrating a structure in which a part of a driving mechanism is removed;

FIG. 5 is a partially enlarged and exploded perspective view of a driving head shown in FIG. 4;

FIG. 6 is a perspective view of the indicating apparatus shown in FIG. 3, illustrating a structure in which a mounting table and a part of a holder adapter are removed;

FIG. 7A is a partially enlarged perspective view of a detecting means shown in FIG. 6, illustrating the adapter set before being attached to the mounting table;

FIG. 7B is a partially enlarged perspective view of a detecting means shown in FIG. 6, illustrating the adapter set after being attached to the mounting table;

FIG. 8 is an enlarged perspective view of a housing holder in the indicating apparatus shown in FIG. 3;

FIG. 9A is a cross sectional view of the housing holder, illustrating the housing holder set before a housing is inserted into the housing holder;

FIG. 9B is a cross sectional view of the housing holder, illustrating the housing holder set when an operating plate is controlled;

FIG. 9C is a cross sectional view of the housing holder, illustrating the housing holder set after the housing is inserted into the housing holder;

FIG. 10 is a plan view of an indicating bar, illustrating an operation of the indicating bar;

FIG. 11 is a block diagram of a control device in the wire harness producing system;

FIG. 12 is a flow chart illustrating a process in a main routine of a controlling means;

FIG. 13 is a flow chart illustrating an electric wire taking-out display shown in FIG. 12;

FIG. 14 is a flow chart illustrating an A-end processing shown in FIG. 12;

FIG. 15 is a flow chart illustrating a B-end processing shown in FIG. 12;

FIG. 16 is a flow chart illustrating a tension test processing in the flow charts shown in FIGS. 14 and 15;

FIG. 17A is a plan view of an indicating bar that indicates a cavity at an access indication position;

FIG. 17B is a plan view of an indicating bar that indicates a cavity at a spaced indication position;

FIG. 18A is a side elevation view of a part of the indicating apparatus in the tension test processing shown in FIG. 16, illustrating the indicating apparatus set before carrying out the tension test processing;

FIG. 18B is a side elevation view of a part of the indicating apparatus in the tension test processing shown in FIG. 16, illustrating the indicating apparatus set regularly in the tension test processing; and

FIG. 18C is a side elevation view of a part of the indicating apparatus in the tension test processing shown in FIG. 16, illustrating the indicating apparatus under excessive tension.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

A preferred embodiment of an apparatus for indicating a terminal insertion position in accordance with the present invention will be described by referring to the drawings.

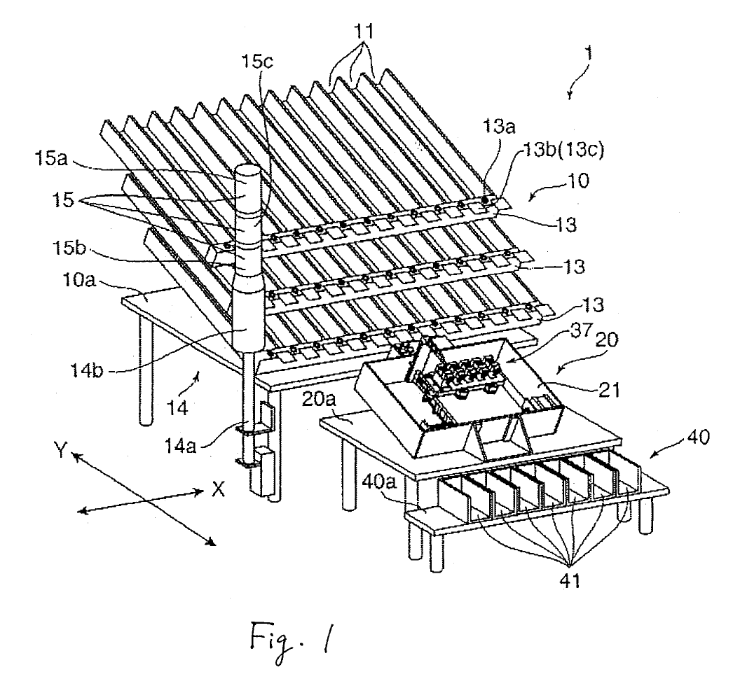

FIG. 1 is a schematic perspective view of a wire harness producing system 1 in an embodiment of the present invention.

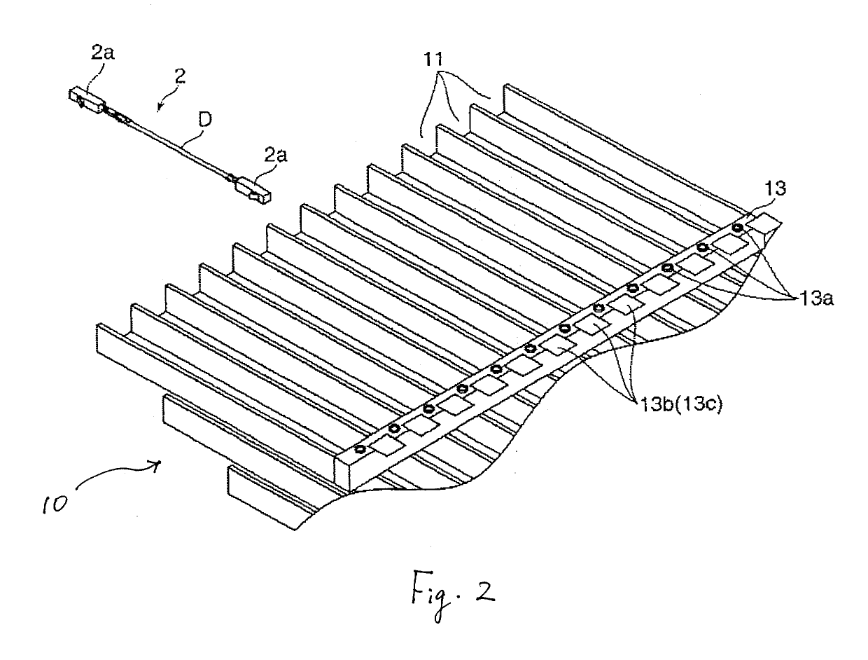

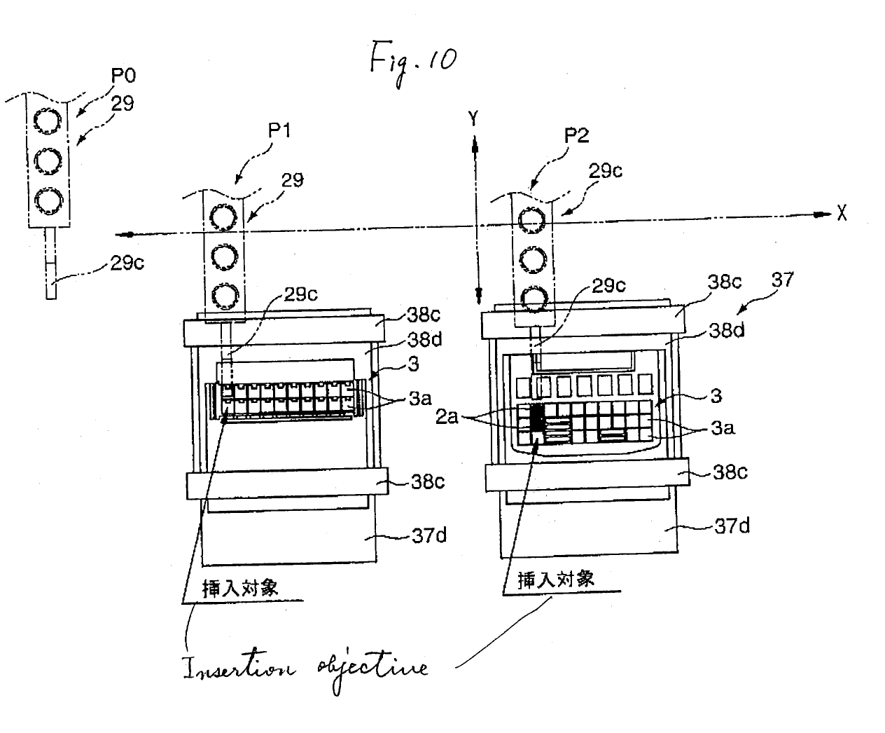

Referring now to FIG. 1, the wire harness producing system 1 produces a wire harness by inserting a terminal 2a (FIG. 2) of an electric wire with terminals 2 into a corresponding cavity 3a (FIG. 10) out of cavities 3a in a plurality of housings 3. The wire harness producing system 1 includes an electric wire container unit 10 for containing various types of electric wires 2 with terminals (FIG. 2) by dividing types of electric wires, an apparatus 20 for indicating a terminal inserting position (hereinafter referred to as an “indicating apparatus”) provided on an end of the electric wire container unit 10, and a housing container unit 40 that is provided on an end of the indicating apparatus 20, opposed to the electric wire container unit 10, and being configured to contain various types of housings 3. The electric wire container unit 10, indicating apparatus 20, and housing container unit 40 are mounted on tables 10a, 20a, and 40a, respectively, that stand lower, in order. A operator occupies a space near the housing container unit 40 opposed to the indicating apparatus 20 in the wire harness producing system 1. The operator inserts the housing 3 (FIG. 10) contained in the housing container unit 40 into a housing holder 37 (described after) of the indicating apparatus 20 and inserts the terminal 2a (FIG. 2) of the electric wire with terminals 2 contained in the electric wire container unit 10 into the cavity 3a (FIG. 10) in the housing 3. Hereinafter, the side that the operator occupies is defined as a front side with respect to the wire harness producing system 1. Left and right directions taken from the front side are defined as the X-direction, and back and forth directions taken from the front side are defined as the Y-direction.

The housing container unit 40 includes a plurality of housing containers 41 arranged in the X-direction on the table 40a. Each housing container 41 may be constructed of any suitable material such as, for example, a synthetic resin material or the like. Each housing container 41 may take any form, and in the present embodiment, is formed into a substantially rectangular parallelepiped container that is open at upper and front sides. Different types of housings 3 may be contained in the respective housing containers 41.

The electric wire container unit 10 includes containing grooves 11 stacked in any number of stages, and in the present embodiment, are stacked in three stages. The containing grooves are juxtaposed in the X-direction in this embodiment.

FIG. 2 is an enlarged perspective view of a part of the electric wire container unit 10 in the wire harness producing system 1.

Referring to FIGS. 1 and 2, each containing groove 11 is formed into a gutter-like configuration and may contain each of different types of electric wires with terminals 2. End portions of the containing grooves 11 are arranged in a step-like configuration, as seen from a side view, and opposed to the indicating apparatus 20. Three coupling bars 13 extending in the X-direction couple the end portions of the containing grooves 11 to one another. The coupling bars 13 define terminal end sections of the respective containing grooves 11. Each coupling bar 13 may be a substantially rectangular member and has a gutter lamp 13a on an upper surface corresponding to each containing groove 11. The gutter lamp 13a switches on and off so that the lamp 13a indicates to an operator that the electric wire with terminals 2 should be taken out from the corresponding containing groove 11. The coupling bar 13 is provided on the upper surface near the gutter lamp 13a with a holder 13c for containing an indicating card 13b. The type (as well as other identifying information) of electric wire with terminals 2 contained in the corresponding containing groove 11 is described on the indicating card 13b. In general, the electric wire with terminals 2 to be inserted into the containing groove 11 is a cable D on opposite ends of which terminals 2a are crimped. On the other hand, a special type electric wire with terminals 2 is, for example, a branched cable D an end of which is different in color or dimension from a trunk cable D, or on an end of which a terminal 2a different in shape from the trunk cable D is fixed (not shown).

The respective containing grooves 11 are inclined toward the operator's position so that the electric wires with terminals 2 contained in the grooves 11 are directed at the operator and secured to the table 10a with the grooves being open at the top. The table 10 is provided on a front left leg with an indicating lamp 14 that sends to a operator a notification that work is completed or of special working conditions. The indicating lamp 14 includes a fixing rod 14a to be secured to the leg of the table 10. The fixing rod 14a extends vertically and a lower end of the rod 14a is secured to the leg of the table 10 while an upper end of the rod 14a is provided with a lamp body 14b. The lamp body 14b is provided on the end opposite to the fixing rod 14a with a three-stage notification lamp unit 15. In this embodiment, the three-stage notification lamp 15 includes a loose end notification lamp 15a at an upper stage, an irregularity notification lamp 15c at a middle stage, and a completion notification lamp 15b at a lower stage. The phrase “loose end” means here that only one of terminals 2a fixed on the opposite ends of the cable D is inserted into the housing 3 during an inserting operation. That is, the other terminal 2a will not be inserted into the housing 3 and will be left as a free end.

Referring to FIG. 1, the indicating apparatus 20 has a casing 21 that forms a container. The casing 21 may take any form, and in the present embodiment, includes a substantially rectangular parallelepiped container that is open at the top. The casing 21 is provided on the table 20a so that longitudinal sides thereof extend in the X-direction. The casing 21 is inclined toward an operator so that the open section is directed to the operator. The casing 21 is secured to the table 20a with the top being open. Before the casing 21 is inclined, the casing 21 extends in a direction normal to an XY-plane is defined as a

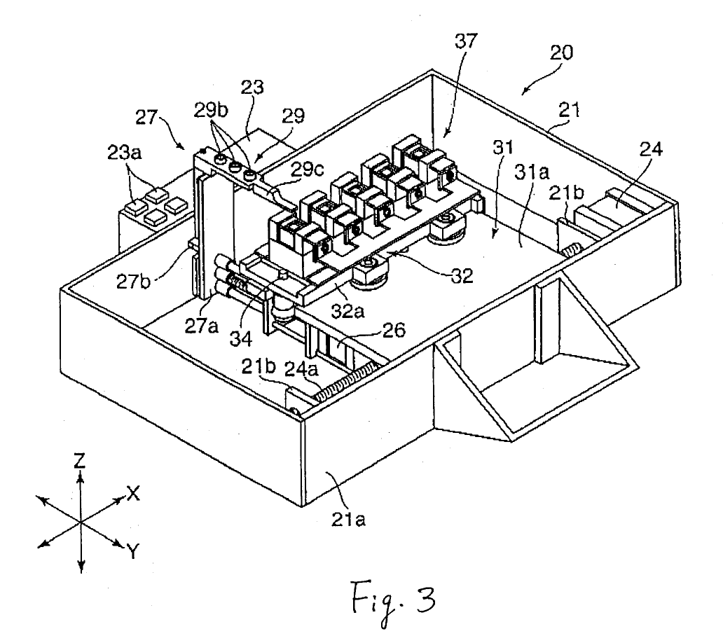

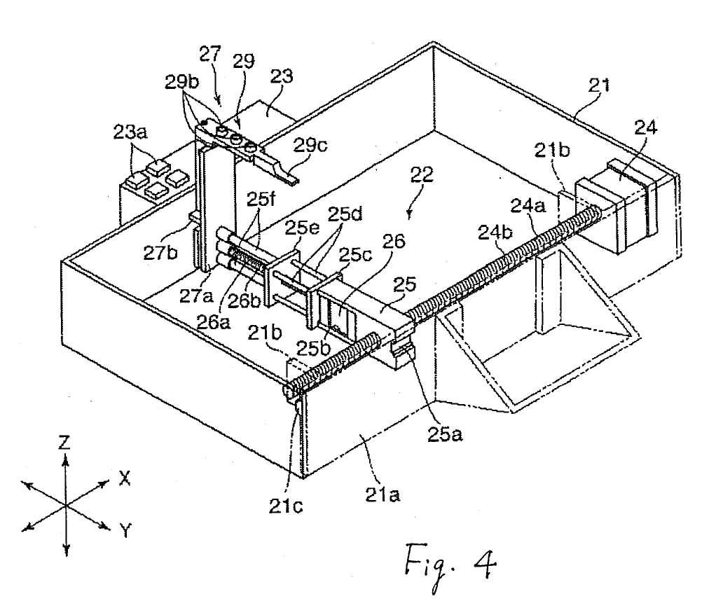

FIG. 3 is an enlarged perspective view of a portion of the indicating apparatus 20 in the wire harness producing system 1 shown in FIG. 1. FIG. 4 is a perspective view similar to FIG. 3, illustrating the indicating apparatus 20 from which a part of a driving mechanism is removed.

Referring to FIGS. 3 and 4, an indicating base 23 is provided on an end of the casing 21 that is opposed to an operator. The indicating base 23 is provided with a pilot lamp 23a for a special type of an electric wire that informs an operator that an insertion objective electric wire with terminals 2 is a special type. For example, an insertion objective terminal 2a out of more than two special terminals 2a of the electric wire with terminals 2 is stuck on the lamp 23a beforehand (not shown). The pilot lamp 23a for a special type electric wire informs an operator of the insertion objective terminal 2a, when the lamp 23a lights up. Even if an inserting operation requires special steps (for example, plural same terminals 2a to be inserted into a single same housing 3 or different insertion directions of the respective terminals 2a), a schematic diagram indicating the process may be provided to the pilot lamp 23a for a special type of electric wire.

An X-axis motor 24 is fixed on a right end of a front surface (hereinafter referred to a base front surface 21a) of the casing 21 opposed to the pilot lamp 23a for a special type of electric wire. The X-axis motor 24 is fixed on the base front surface 24 so that the motor 24 extends in the X-direction in the casing 21. The X-axis motor 24 holds an end of a ball screw shaft 24a. The other end of the ball screw shaft 24a is disposed to extend to the left side on the X-axis and supported in a pair of bearings 21b provided near the right and left ends of the base front surface 21a. The ball screw shaft 24a is provided on the outer periphery with a screw groove 24b. A driving block 25 is mounted through a ball nut on the screw groove 24b between the bearings 21b. The driving block 25 that may take any form, and in the present embodiment, includes a substantially rectangular parallelepiped block. The driving block may be made of any suitable material such as, for example, a metallic material or the like, and the longitudinal sides of the block 25 extend in the Y-direction. The driving block 25 is provided on a front end thereof with a sliding groove 25a. The sliding groove 25a slidably engages a sliding rib 21c provided on the base front surface 21a in the X-direction. The driving block 25 is provided with a motor containing chamber 25b that is open at an end opposed to the base front surface 21a and extends in the X-direction. A Y-axis motor 26 is contained in the motor containing chamber 25b.

The Y-axis motor 26 holds an end of a ball screw shaft 26a disposed in the Y-direction and is secured in the motor containing chamber 25b. The ball screw shaft 26a is supported by a bearing plate 25c provided on the driving block 25 and a bearing plate 25e coupled to the bearing plate 25c through four poles 25d in the Y-direction. The ball screw shaft 26a is provided on the outer periphery with a screw groove 26b. A driving head 27 is mounted through a ball nut on the screw groove 26b near the other end of the ball screw shaft 26a. The driving head 27 is supported slidably by a pair of guide bars 25f that extend in the Y-direction from the bearing plate 25e at upper and lower positions adjacent the ball screw shaft 26a. In this embodiment, the X-axis motor 24, driving block 25, Y-axis motor 26, and driving head 27 serve as a driving mechanism 22.

FIG. 5 is a partially enlarged perspective view of the driving head 27 shown in FIG. 4.

Referring to FIGS. 3, 4, and 5, the driving head 27 includes a driving base 27a. The driving base 27a may take any form, and in the present embodiment, includes a substantially rectangular parallelepiped plate member made of a any suitable material such as, for example, metallic material or the like. The driving base 27a is provided in the casing 21 so that a width of the base extends in the X-direction and longitudinal sides of the base extend along the Z-direction. A lower end of the driving base 27a is supported by the ball screw shaft 26a and the respective guide bars 25f. A lower end block 27b is provided on an intermediate portion of the driving base 27a to extend toward the indicating base 23 in the Y-direction. A rail 27c is provided on a side surface of the driving base 27a above the lower end block 27b. The rail 27c extends in the Z-direction to a position slightly lower than the upper end of the driving base 27a. Sliders 28a are mounted slidably on the rail 27c and prevented from coming out of the rail 27c upwardly in the Z-direction. An upper end block 27d is fixed on an upper end of the rail 27c adjacent the side surface of the driving base 27a. The upper end block 27d prevents the sliders 28a from coming out of the rail 27c upwardly in the Z-direction. The sliders 28a are secured to a coupling base 28b of a coupling section 28 by bolts 28c. The coupling base 28b may take any form, and in the present embodiment, includes a substantially rectangular parallelepiped plate member, and may be made of any suitable material such as, for example, a metallic material or the like. The coupling base 28b is provided in the casing 21 so that a width of the base 28b extends in the X-direction and longitudinal sides of the base 28b extend in the Z-direction. An indication bar 29 is provided on an upper end of the coupling base 28b.

The indicating bar 29 includes an indicating base 29a that extends from the upper portion of the coupling base 28b toward the base front surface 21a in the Y-direction. The indicating base 29a may take any form, and in the present embodiment, includes a substantially rectangular parallelepiped plate member, and may be made of any suitable material such as, for example, a metallic material or the like. The indicating base 29a is arranged in the casing 21 so that a width of the base 29a is in parallel with the XY-plane and longitudinal sides of the base 29a extend in the Y-direction. In the present embodiment, three pilot lamps 29b that serve as indicators are juxtaposed along the Y-direction on the upper surface of the indicating base 29a. Furthermore, an indicating finger 29c is provided on an end of the indicating base 29 in the Y-direction. The indicating finger 29c may take any form, and in the present embodiment, includes a substantially rectangular parallelepiped plate member, and may be made of any suitable material such as, for example, a metallic material or the like and is arranged in the casing 21 so that a width of the finger 29c extends in the Z-direction and longitudinal sides of the finger 29c extend in the Y-direction. With this configuration, the indicating finger 29c is fixed on the indicating base 29a so that the upper surfaces of the finger 29c and base 29a are aligned with each other. The indicating finger 29c is provided with a cut-off portion 29d extending from an intermediate portion to a distal end.

The lower end block 27b and coupling base 28b are provided with supporting pins 27e and 28d, respectively. The supporting pins 27e and 28d extend toward the indicating base 23 in the Y-direction. A tension spring 30 is bridged between the supporting pins 27e and 28d. The coupling base 28b is normally retracted to the lower end block 27b by the tension spring 30 so that the coupling base 28b can move relative to the lower end block 27b in the Z-direction under an elastic force. Thus, since the coupling base 28b is movable with respect to the lower end block 27b, the coupling base 28b can move under an elastic force in association with movement of the housing holder 37 during a tension test processing R described after. With this configuration, the indicating finger 29, as shown in FIG. 3, is provided in the Z-direction at a position higher than the housing holder 37 on a mounting table 31 described after.

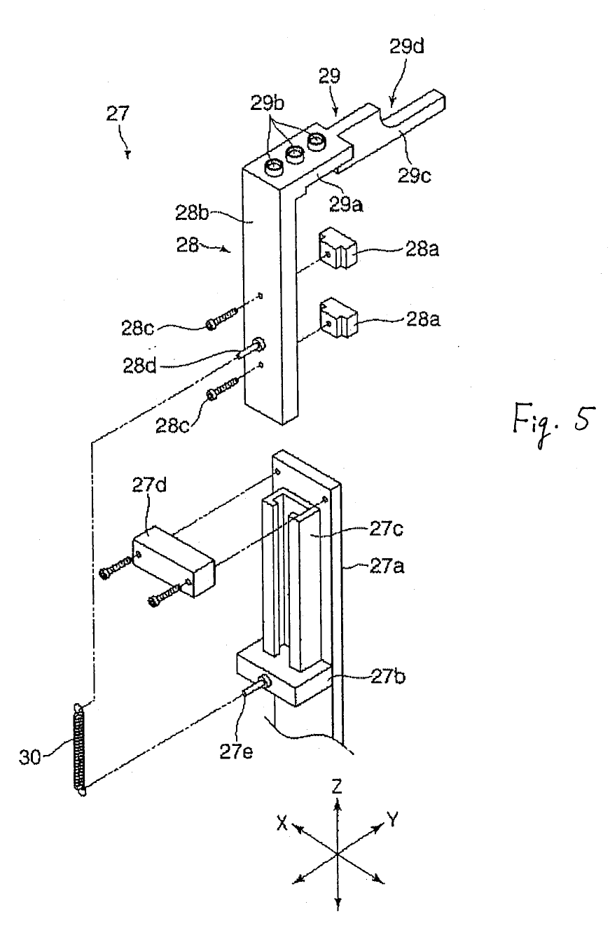

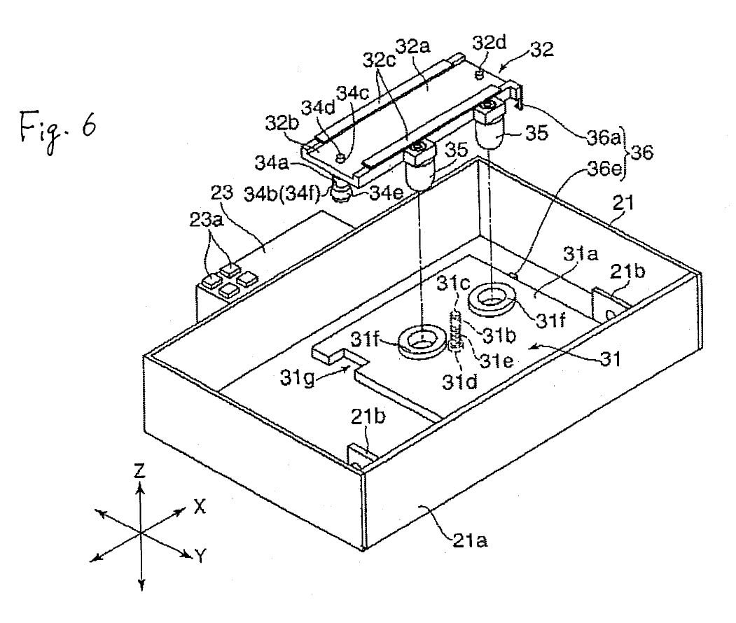

FIG. 6 is a perspective view of the indicating apparatus 20 shown in FIG. 3, illustrating the mounting table 31 and a part of the holder adapter 32 being omitted.

Referring to FIGS. 3 and 6, the mounting table 31 includes a table body 31a fixed on the base front surface 21a above the driving mechanism 22 in the Z-direction. The table body 31a may take any form, and in the present embodiment, includes a substantially rectangular parallelepiped plate member, and may be made of any suitable material such as, for example, a metallic material or the like. The table body 31a is fixed on the base front surface 21a so that a width of the body 31a extends in the Y-direction and longitudinal sides extend in the X-direction. The table body 31a is provided on a substantially middle position with a through-hole 31b extending in the Z-direction. A sliding pin 31c that has an anti-falling-off flange 31d on an end thereof penetrates the through-hole 31b from the bottom surface of the table body 31a. A compression coil spring 31e is compressed between the anti-falling-off flange 31d and the table body 31a so that the spring 31e encloses the sliding pin 31c. On the other hand, the end of the sliding pin 31c is secured to a lower surface of the holder adapter 32. That is, the holder adapter 32 is biased toward the table body 31a by the coil spring 31e.

The holder adapter 32 includes a substantially rectangular parallelepiped plate-like adapter body 32a. The adapter body 32a is arranged in the casing 21 so that a width of the body 32a extends in the Y-direction and longitudinal sides extend in the X-direction. The adapter body 32a is provided with a sliding groove 32b extending in the longitudinal direction of the adapter body 32a. A pair of anti-falling-off plates 32c are provided in the X-direction on the opposite side ends of the adapter body 32a that define the sliding groove 32b. Each anti-falling-off plate 32c may take any form, and in the present embodiment, includes a substantially rectangular parallelepiped plate member, and may be made of any suitable material such as, for example, a metallic material or the like. The anti-falling-off plate 32c is arranged in the casing 21 so that a width of the plate 32c extends in the Y-direction and longitudinal sides extend in the X-direction. A longitudinal side end surface of the anti-falling-off plate 32c is aligned with a longitudinal side end surface of the adapter body 32a. With this configuration, the other longitudinal side end surfaces of the respective anti-falling-off plates 32c cover a part of the sliding groove 32a.

A stopper pin 32d extends in the Z-direction on a right end of the sliding groove 32b in the X-direction. A detachable member 34 is provided on a left end of the sliding groove 32b in the X-direction. The detachable member 34 includes a substantially cylindrical fixing section 34a. A longitudinal axis of the fixing section 34a extends in the Z-direction. The fixing section 34a is provided on a lower end with a slot 34b extending along a diameter of the section 34a. On the other hand, an upper end of the fixing section 34a is secured to a lower surface of the adapter body 32a. Under these conditions, an aperture 34c is formed to penetrate the fixing section 34a and adapter body 32a in the Z-direction. A detachable pin 34d penetrates the aperture 34c so that an end of the pin 34d projects from an upper surface of the adapter body 32a. A grip 34e is provided on a lower end of the detachable pin 34c. The grip 34e is a substantially truncated cone made of any suitable material such as, for example, a metallic material. A rib 34f is provided on an upper end surface of the grip 34e to be opposed to the slot 34b and to extend along a diameter of the grip 34e. The grip 34e is biased toward the fixing section 34a in the Z-direction by a spring (not shown). The rib 34f is normally held on the fixing section 34a with the rib 34f being engaged with the slot 34b. When the grip 34e is drawn downwardly under an elastic force in the detachable member 34, the upper end of the detachable pin 34d is retracted downwardly from the upper surface of the adapter body 32a. Under these conditions, when the grip 34e is rotated about the detachable pin 34d, since the rib 34f is not engaged with the slot 34b, the grip 34e is held on the fixing section 34a.

A pair of guide shafts 35 are provided on an end of the adapter body 32a at the side of the base front surface 21a to extend downwardly in the Z-direction. These guide shafts 35 are cylindrical members that may be made of any suitable material such as, for example, metallic material or the like. The guide shafts 35 are inserted into a pair of bearings 31f provided at corresponding positions of the table body 31a. The guide shafts 35 are held in the table body 31a slidably in the Z-direction by the bearings 31f. The detachable member 34 is prevented from interfering with the table body 31a by an escape slot 31g provided at a corresponding position of the table body 31a.

As described above, the holder adapter 32 is supported on the mounting table 31 movably in the Z-direction. A detecting means 36 is provided on the holder adapter 32 and mounting table 31 to detect a relative movement between the holder adapter 32 and the mounting table 31.

FIG. 7A is a partially enlarged perspective view of the detecting means 36 shown in FIG. 6, illustrating the holder adapter 32 before being attached to the mounting table 31. FIG. 7B is a partially enlarged perspective view of a detecting means 36 shown in FIG. 6, illustrating the holder adapter 32 after being attached to the mounting table 31.

Referring to FIGS. 6 and 7A, the adapter body 32a is provided on a right end in the X-direction with a detecting plate 36a extending in the Z-direction. The detecting plate 36a is provided on an upper end in the Z-direction with a fixing plate 36b directed to the indicating base 23 in the Y-direction. The fixing plate 36b is secured to the adapter body 32a by bolts 36c. On the other hand, the detecting plate 36a is provided on a lower end in the Z-direction with a shielding plate 36d that extends in parallel with the fixing plate 36b.

On the other hand, a detecting base 36e is secured to a right end of the table body 31a in the X-direction. The detecting base 36e may take any form, and in the present embodiment, includes a substantially rectangular parallelepiped plate member, and may be made of any suitable material such as, for example, a metallic material or the like. The detecting base 36e is fixed on the table body 31a so that a width of the base 36e extends in the Y-direction and longitudinal sides of the base 36e extend in the Z-direction. Sensors “a” and “b” are juxtaposed in the Z-direction on a right side surface of the detecting base 36e. The sensors “a” and “b” include detecting slots “a1” and “b1”, respectively. The detecting slots “a1” and “b1” are open toward the base front surface 21a in the Y-direction and extend in the Z-direction. Two pairs of leg sections “a2” and “b2” that define the respective detecting slots “a1” and “b1” include photo-receiver and transmitter sets (not shown) that receive and transmit light between them. The photo-receiver and transmitter sets can detect whether a light path is cut off or not.

Referring to FIGS. 6 and 7B, when the holder adapter 32 is attached to the mounting table 31, the shielding plate 36d is opposed to the detecting slot “a1” in the sensor “a”. On the other hand, the detecting plate 36a is disposed in the detecting slot “b1” in the sensor “b”. Since the light-receiving and light-transmitting processes are carried out in a position corresponding to the shielding plate 36d in the Y-direction, only the light from the sensor “a” is cut off in this condition.

A housing holder 37 is disposed on the holder adapter 32 constructed above.

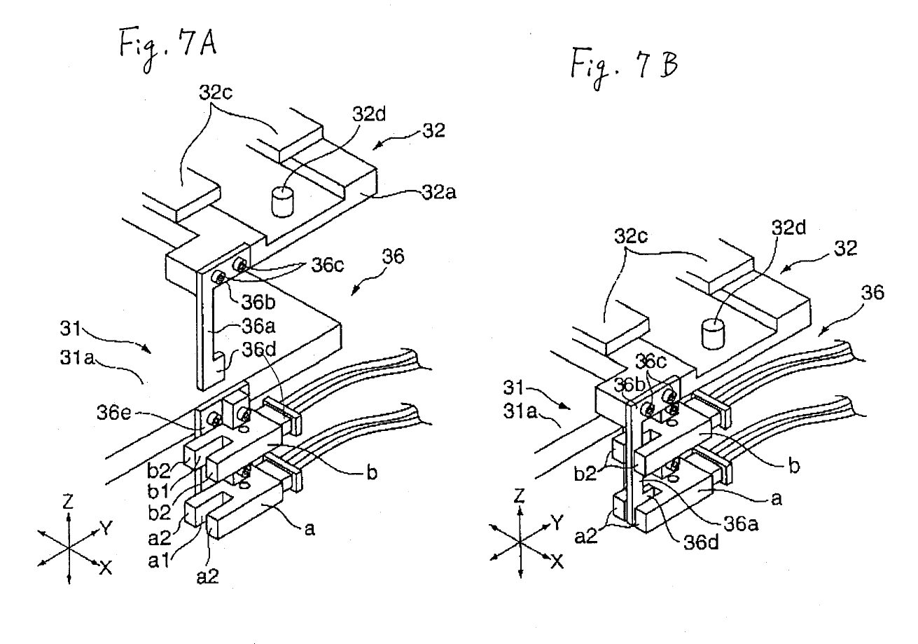

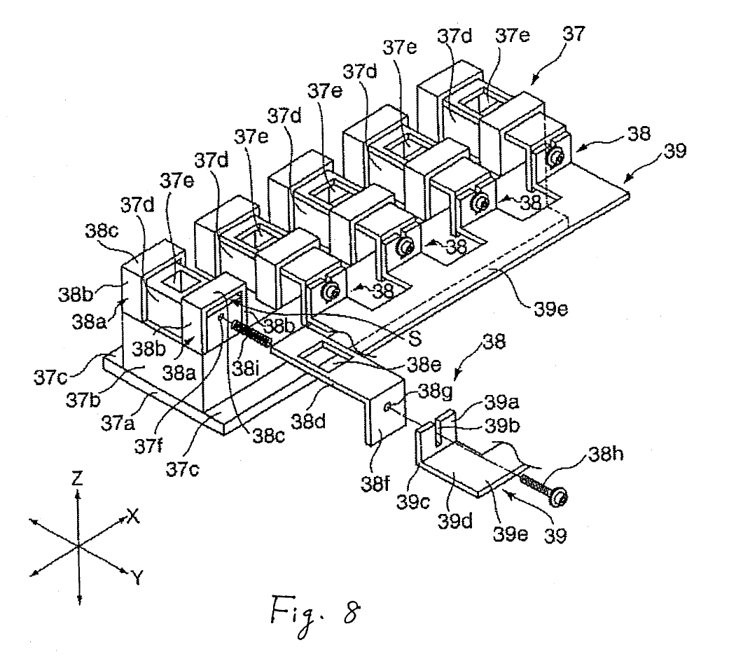

FIG. 8 is an enlarged perspective view of the housing holder 37 in the indicating apparatus 20 shown in FIG. 3.

Referring to FIGS. 3, 6, and 8, the housing holder 37 includes a holder base 37a that may take any form, and in the present embodiment, includes a substantially rectangular parallelepiped plate member, and may be made of any suitable material such as, for example, a synthetic resin material or the like. The holder base 37a is arranged in the casing 21 so that a width of the base 37a extends in the Y-direction and longitudinal sides of the base 37a extend in the X-direction. A raised block 37b having a width slightly smaller than that of the holder base 37a is secured to the holder block 37b. The raised block 37b has the substantially same longitudinal dimension as that of the holder base 37a. The raised block 37b is fixed on the upper surface of the holder base 37a in the Z-direction in alignment with their longitudinal dimensions. When the raised block 37b is fixed on the holder base 37a, sliding ends 37c are formed on the opposite ends of the holder base 37a. Five containing blocks 37d are provided on an upper surface of the raised block 37b in the Z-direction in the present embodiment. Each containing block 37d may take any form, and in the present embodiment, includes a substantially rectangular parallelepiped plate member, and may be made of any suitable material such as, for example, a synthetic resin material or the like. The containing block 37d is arranged on the raised block 37b so that the respective sides extend in the X, Y, and Z-directions. At the same time, each containing block 37d is provided with a housing positioning-hole 37e for containing each housing 3. The containing blocks 37d are juxtaposed on the raised block 37d with the housing positioning-holes 37e being open in the Z-direction. Since each housing positioning-hole 37e directs each cavity 3a in the housing 3 in the given X and Y-directions, the housing 3 is provided on the containing block 37d so that the cavities 3a are arranged in the given X and Y-directions. A switching mechanism 38 is provided on each containing block 37d.

The switching mechanism 38 includes a pair of covers 38a provided on the opposite ends of each containing block 37d in the Y-direction. The cover 38a is a reversed U-shaped plate-like member having a top 38c and a pair of legs 38b. The pair of legs 38b are fixed on the side surfaces of the containing block 37d in the X-direction. When each leg 38b is fixed on the containing block 37d, a sliding space S is defined between the top 38c and the upper surface of the containing block 37d in the Z-direction. A cover plate 38d that serves as a regulating member is contained slidably in the sliding space S. The cover plate 38d is a substantially parallelepiped plate member made of a metallic material or the like. Each cover plate 38d is provided with an opening 38e having the substantially same dimension as that of the housing positioning-hole 37e. An end of each cover plate 38d in the Y-direction is contained in the sliding space S with the opening 38e being open upwardly in the Z-direction. On the other hand, the other end of each cover plate 38d includes a pushing plate 38f bent down in the Z-direction. The pushing plate 38f is provided with pushing through-hole 38g. A bolt 38h penetrates the pushing through-hole 38g through a driving member 39 described after (in FIG. 8, a part of the member 39 is broken away and assembled and disassembled positions of the member 39 are shown respectively). The bolt 38h is fixed through a compression coil spring 38i in screwed hole 37f in the containing block 37d. That is, the compression coil spring 38i is compressed between the containing block 37d and the pushing plate 38f.

The driving member 39 includes fixing plates 39a disposed in parallel with the pushing plates 38f. Each fixing plate 39a is provided with a fixing slot 39b that is open in the Z-direction and extends toward the containing block 37d. When a bolt 38h is secured through the fixing slot 39b to the containing block 37d, each fixing plate 39a is secured to the pushing plate 38f. An extension plate 39d is provided through a bent portion 39c on a lower end of each fixing plate 39a in the Z-direction. An operating plate 39e couples ends of the extension plates 39d to one another in the Y-direction.

The sliding end 37c of the housing holder 37 as constructed above is contained in the sliding slot 32b in which the grip 34e of the holder adapter 32 is pulled down. When the grip 34e is returned to an upper position, the housing holder 37 is secured to the holder adapter 32 between the stopper pin 32d and the detachable pin 34d. With this configuration, an operator inserts the housing 3 into the housing holder 37.

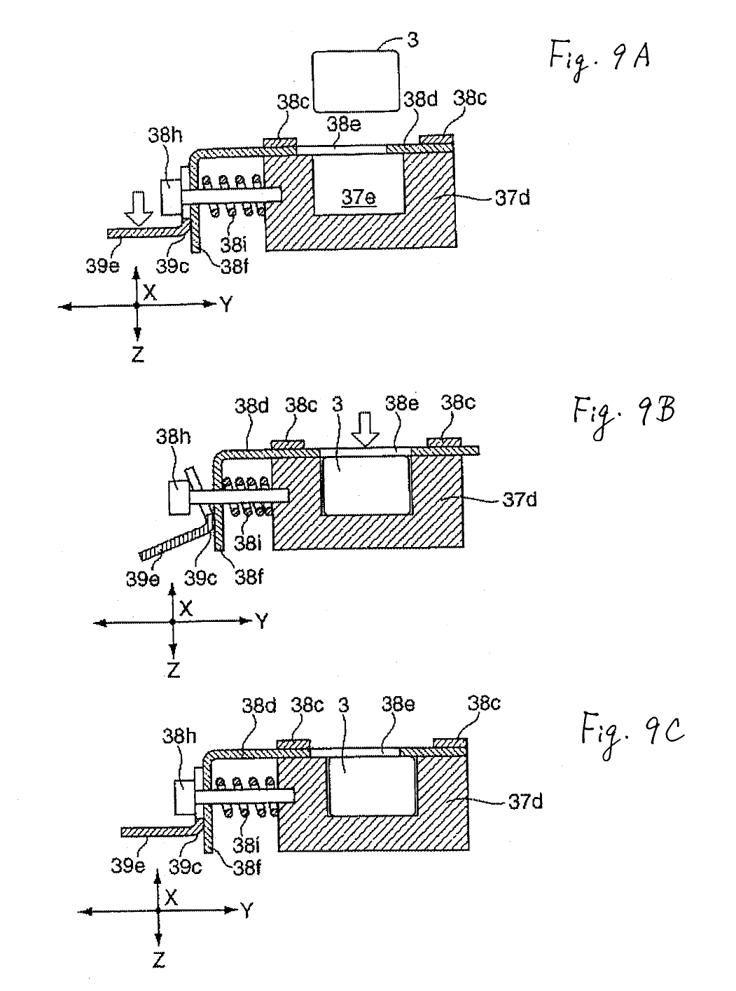

FIG. 9A is a cross sectional view of the housing holder 37, illustrating the housing holder 37 set before the housing 3 is inserted into the housing holder 37. FIG. 9B is a cross sectional view of the housing holder 37, illustrating the housing holder 37 set when the operating plate 39e is controlled. FIG. 9C is a cross sectional view of the housing holder 37, illustrating the housing holder 37 set after the housing 3 is inserted into the housing holder 37.

Referring to FIGS. 8 and 9A, before the housing 3 is inserted into the housing holder 37, the cover plate 38d is biased toward the containing block 37d by the compression coil spring 38i so that the housing-positioning hole 37e is slightly shifted from the opening 38e in the Y-direction. Under this condition, a part of an opening end of the housing positioning hole 37e is covered with the cover plate 38d. Thus, the housing 3 is restrained from being inserted in the housing positioning hole 37e downwardly in the Z-direction. When an operator inserts the housing 3 into the housing positioning hole 37e, the operator operates the operating plate 39e.

Referring to FIGS. 8 and 9B, when the operating plate 39e is turned down in the Z-direction about the bent portion 39c, the bent portion 39c is rotated in a counter clockwise direction about a head of the bolt 38h in FIG. 9. Consequently, since the bent portion 39c is moved to the containing block 37d in the Y-direction, the pushing plate 38f is pushed in the same direction by the bent portion 39c. When the pushing plate 38f is pushed, the opening 38e is aligned with the housing-positioning hole 37e in the Y-direction. Under this condition, an operator inserts the housing 3 into the housing-positioning hole 37e with the cavity 3a being open upwardly in the Z-direction.

Referring to FIGS. 8 and 9C, when the operating plate 39e is released, the cover plate 38d is returned to a position shown in FIG. 9A by a compression coil spring 38i. Under this condition, since a part of the housing 3 is covered with the cover plate 38d, the housing 3 is restrained from moving upwardly in the Z-direction. The cover plate 38d covers a part of the housing 3 at a position where the cavity 3a is not provided (not shown).

When an operator inserts the housing 3 into the housing holder 37, the indicating apparatus 20 indicates an insertion objective cavity by the indicating bar 29.

FIG. 10 is a plan view of a part of the indicating bar 29, illustrating an indicating operation of the bar 29.

Referring to FIG. 10, the indicating bar 29 is moved in the X and Y-directions with respect to the housing holder 37 by the driving mechanism 22. In this embodiment, the indicating finger 29c of the indicating bar 29 moves among an initial position P0 where the bar 29 is spaced away from all housings 3 contained in the housing holder 37 at the left side in the X-direction and at the upper side in the Y-direction, an access indicating position P1 where the bar 29 moves slightly above a coordinate on the Y-axis to indicate the insertion objective cavity 3a while moving along a coordinate on the X-axis corresponding to the insertion objective cavity 3a in the X-direction, and a spaced indicating position P2 where the bar 29 moves above and slightly away from a coordinate on the Y-axis to indicate the insertion objective cavity 3a while moving along a coordinate on the X-axis corresponding to the insertion objective cavity 3a when another terminal 2a has been already inserted in a cavity 3a near the insertion objective cavity 3a.

The wire harness producing system 1 constructed above includes a control device 50 that controls the above constituent components in order to indicate the insertion objective cavity 3a and electric wire with terminals 2 to a worker.

FIG. 11 is a block diagram of the control device 50 in the wire harness producing system 1.

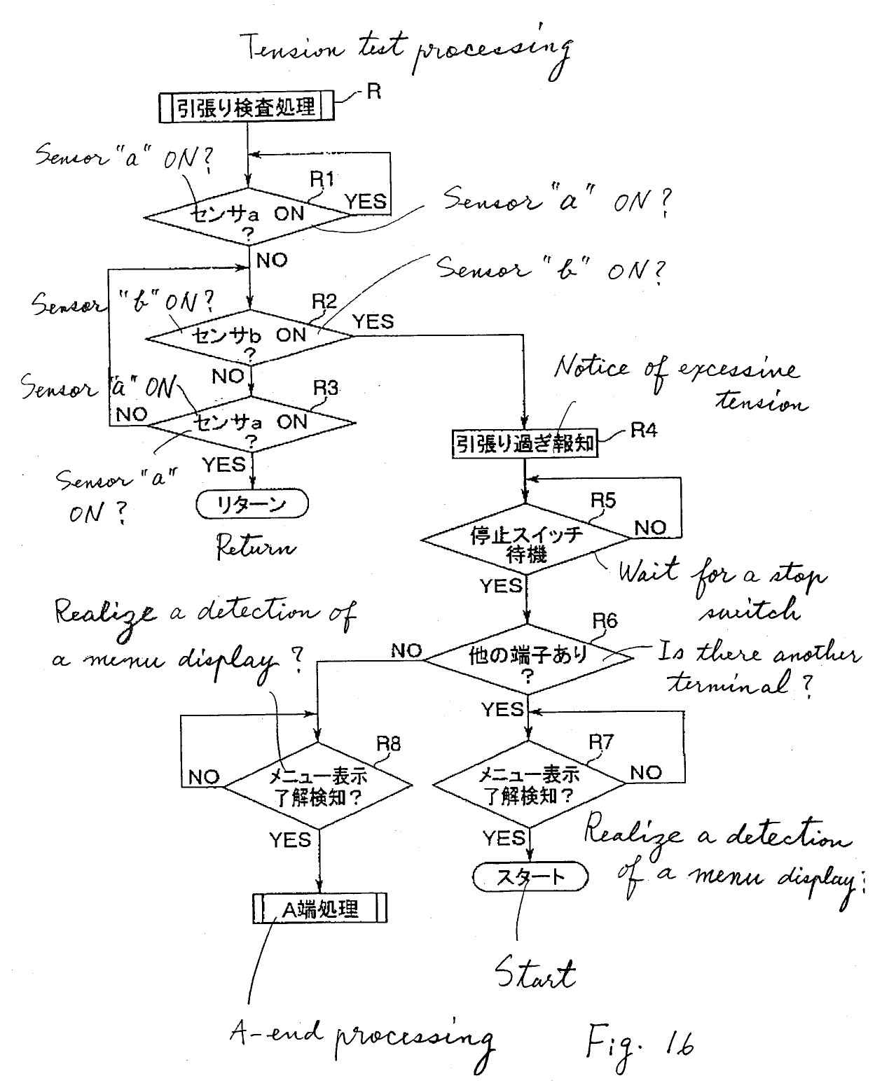

Referring to FIG. 11, the control device 50 includes a CPU (central processing unit) 51 for carrying out various kinds of processing. An input means 52 and an operating means 53 are coupled to the CPU 51 to communicate with each other. The input means 52 and operating means 53 output to the CPU 51 information concerning the housing 3 and electric wire with terminals 2a of a wire harness to be produced by an operator, their inserting orders, and X and Y coordinates at which the indicating finger 29c indicates an insertion objective cavity 3a in connection with the inserting orders (that is, X and Y coordinates at the access indicating position P1 or spaced indicating position of the indicating finger 29c). In the case where an operator sets the indicating finger 29c to indicate the cavity 3a at the space indicating position P2, a position of an indicating lamp 29b out of the respective indicating lamps 29b that is lit up in correspondence with the insertion objective cavity 3a is inputted in the CPU 51 (see FIG. 17). This information is processed by the CPU 51 and stored in a memory means 54. The memory means 54 is connected to the CPU 51 so that the memory means 54 can read out and write data. The CPU 51 reads out information from the memory means 54 any time and gives command to the controlling means 55 to control the respective constituent components. The controlling means 55 is connected to a buzzer 56 for generating an alarm, the X-axis motor 24, the Y-axis motor 26, the indicating lamps 29b, the special type electric wire pilot lamp 23a, the gutter lamp 13a, the loose end pilot lamp 15a, the completion pilot lamp 15b, and the irregularity pilot lamp 15c described above, respectively. In order to actuate the constituent components in the order that is stored in the memory means 54, the controlling means 55 receives outputs from the sensors “a” and “b” described above. Furthermore, a display panel 57 is connected to the controlling means 55 so that an operator can confirm various information stored in the memory means 54 and controlled states of the respective constituent components of the controlling means 55.

The wire harness producing system 1 drives the respective constituent components in accordance with the order of insertion and indicates the insertion objective cavity to a worker by the controlling means 55 constructed above. Referring to the drawings, processing of the controlling means 55 will be described below.

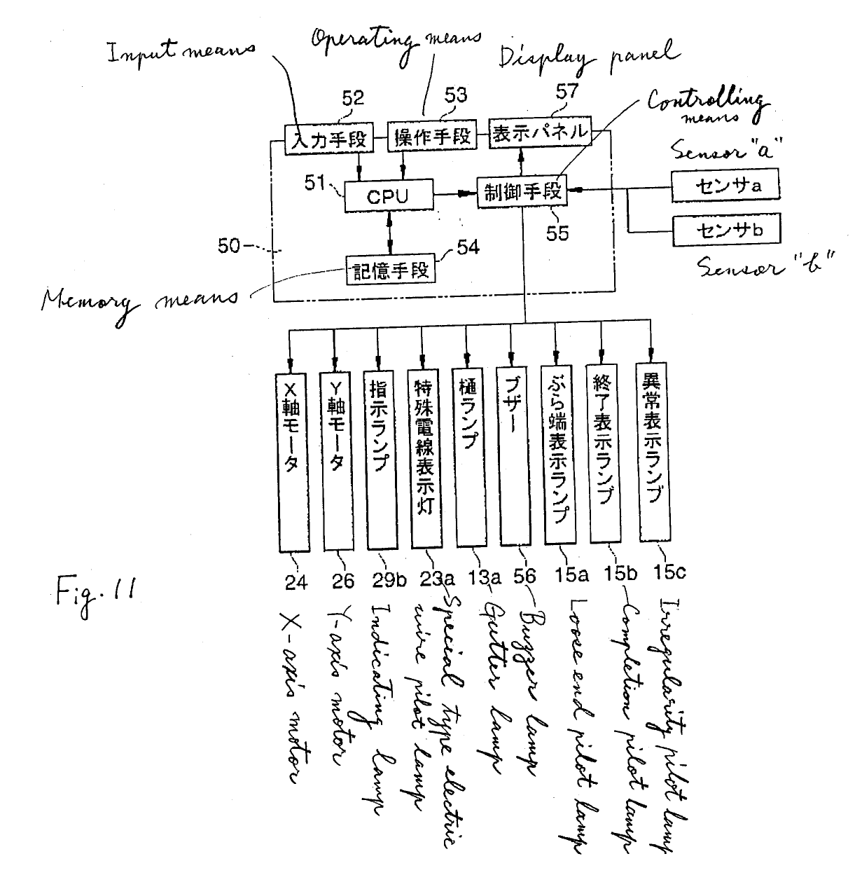

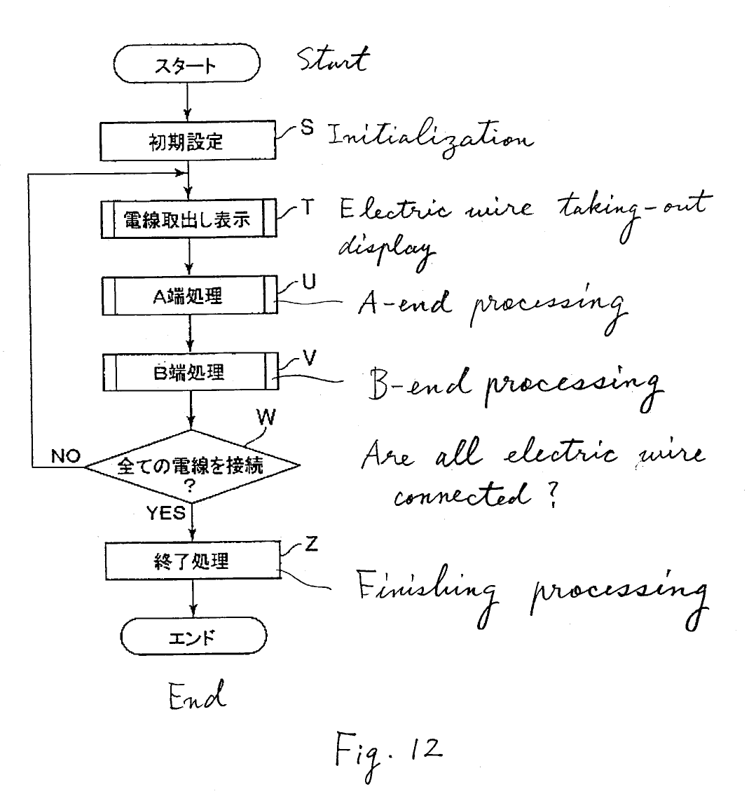

FIG. 12 is a flow chart illustrating a processing in a main routine of the controlling means 55.

Referring to FIG. 12, when the processing of the controlling means 55 starts in the main routine, an initialization is carried out (step S). In this initialization, the controlling means 55 is reset and the respective constituent components are returned to initial states. Then, an electric wire taking-out display is executed to indicate the insertion objective electric wire with terminals 2 (step T). After the operator takes out the electric wire with terminals 2, an A-end processing is executed to indicate the cavity 3a in the housing holder 37 corresponding to a housing 3 (step U). The “A-end” means a priority one (hereinafter referred to as “A-end”) of the terminals 2a of the electric wire with terminals 2 should be inserted into the corresponding housing 3. After the operator inserts the A-end into the corresponding cavity 3a, a B-end processing is executed to indicate the cavity 3a in the housing holder 37 corresponding to a housing 3 (step V). The “B-end” means the other terminal (hereinafter referred to as “B-end”) of the terminals 2a of the electric wire with terminals 2 should be inserted into the corresponding housing 3. After the operator inserts the B-end into the corresponding cavity 3a, a decision is executed to decide whether all electric wires with terminals 2 having the B-ends are inserted into the corresponding cavities or not (step W). If it is decided that there is any electric wire with terminals 2 that is not inserted, the processing from the step T to the step V is repeated. On the other hand, if it is decided that all electric wire with terminals 2 are inserted, a finishing processing is executed (step Z) to finish the processing of the controlling means 55. In this finishing processing, the completion pilot lamp 15b is lit up and the indicating finger 29c moves to the initial position P0 shown in FIG. 10.

FIG. 13 is a flow chart illustrating the electric wire taking-out display shown in FIG. 12.

Referring to FIG. 13, when the processing of the electric wire taking-out display starts, information concerning all electric wires with terminals 2 in an inserting work is read out from the memory means 54 (step T). The information concerning the electric wires with terminals 2 includes types of electric wires with terminals to be used in the inserting work and an inserting order. When the information is read out, gutter lamps 13a corresponding to all electric wires with terminals 2 to be used in the inserting work out of electric wires with terminals 2 contained in the electric wire container unit 10 are lit up (step T2). After the various types of the lamps 13a are lit up, only the gutter lamp 13a corresponding to the insertion objective electric wire with terminals 2 flashes (step T3). Then, the processing of the controlling means 55 is advanced to the A-end processing.

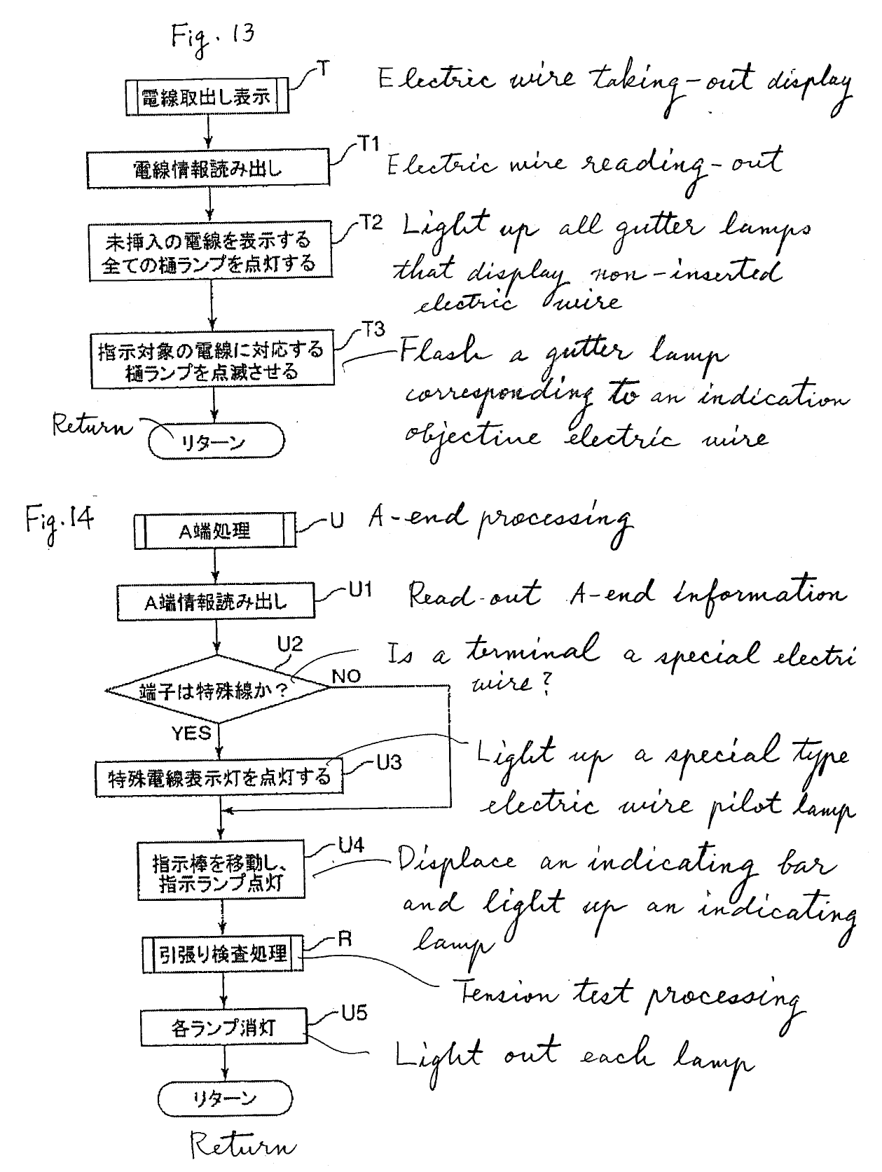

FIG. 14 is a flow chart illustrating the A-end processing shown in FIG. 12. FIG. 17A is a plan view of the indicating bar 29 that indicates the cavity 3a at the access indicating position P1 in the steps U5 and U6 in FIG. 14. FIG. 17B is a plan view of the indicating bar 29 that indicates the cavity 3a at the spaced indicating position P2 in the steps U5 and U6 in FIG. 14.

Referring to FIGS. 14 and 17, when the A-end processing starts, the A-end information is read out from the memory means 54 (step U1). The A-end information includes position information of the A-end to be inserted into the cavity 3a. After the A-end information is read out, it is decided in accordance with the A-end information whether or not the A-end is a special type electric wire (step U2). If it is decided that the A-end is not a special type electric wire, the processing will be continued. Then, the indicating finger 29c is displaced above the predetermined X and Y coordinates and the indicating lamp 29b is lit up, if it is set (step U4).

In the case where the step U4 is executed and the indicating finger 29c is set beforehand to be at the access indicating position P1 by an operator, the indicating bar 29 is displaced to the position shown in FIG. 17A by driving the X-driving motor 24 and Y-driving motor 26. Under this condition, since a proximal end of the indicating finger 29c of the indicating bar 29 is opposed to the vicinity of the insertion objective cavity 3a at an upper side on the Y-axis, a worker can easily find the cavity 3a. On the other hand, in the case where the step U4 is executed and the indicating finger 29c is set beforehand to be at the spaced indicating position P2 by a worker, the indicating bar 29 is displaced to the position shown in FIG. 17B by driving the X-driving motor 24 and Y-driving motor 26, and the indicating lamp 29b that is set beforehand is lit up. Under this condition, the position of the indicating finger 29c in the X-direction specifies the position in the X-direction of the insertion objective cavity 3a and the indicating lamp 29b (the lowest stage) corresponding to the insertion objective cavity 3a out of the cavities 3a arranged in the Y-direction to specify the position in the Y-direction. Accordingly, an operator can find the insertion objective cavity 3a.

Referring to FIG. 14, when the insertion objective cavity 3a is indicated, the operator inserts the terminal 2a into the cavity 3a. After executing a tension test processing R described after, in the case where the indicating lamp 29b is lit up, the indicating lamp 29b is put out and the flashing gutter lamp 13a is put out (step U5). Then, the processing of the controlling means 55 is advanced to the B-end processing.

FIG. 15 is a flow chart illustrating the B-end processing shown in FIG. 12.

Referring to FIG. 15, when the B-end processing starts, the B-end information is read out from the memory means 54 (step V1). The B-end information includes position information of the cavity 3a to receive the terminal 2a. When the B-end information is read out, it is decided in accordance with the B-end information whether or not the insertion objective terminal 2a is a loose end terminal (step V2). If it is decided that the B-end is the loose end terminal, the loose end pilot lamp 15b is lit up and the buzzer 56 is actuated (step V3). A message, which inquires about whether or not the operator recognizes that the B-end is the loose end, is displayed on the display panel 57. The operating means 53 waits for inputting an answer to the question (step V4). When the operator inputs the answer, the loose end pilot lamp 15b is lit out and the buzzer 56 stops sounding (step V5). The processing of the controlling means 55 is advanced to a step W.

On the other hand, when it is decided that the B-end is not the loose end in the step V2, it is decided in accordance with the B-end information whether or not the B-end is a special type electric wire (step V6). If it is decided that the B-end is the special type electric wire, the special type electric wire pilot lamp 23a is lit up (step V7). If it is decided that the B-end is not the special type electric wire, the processing will be continued. Then, the indicating bar 29 moves to the predetermined X and Y-coordinates, as described above, the indicating lamp 29b is lit up, if the lamp is set to be lit up beforehand, to indicate the insertion objective cavity 3a (step V8). After the insertion objective cavity 3a is indicated, as described above, an operator inserts the terminal 2a into the cavity 3a. Then, after executing a tension test processing R described after, the special type electric wire pilot lamp 23a and indicating lamp 29b are put out (step V9). The processing of the controlling means 55 is advanced to the step W.

Thus, the terminal 2a inserted into the indicated cavity 3a by the indicating apparatus 20 should be fixed in the cavity 3a. In order to confirm the fixing of the terminal, the above tension test processing R is executed.

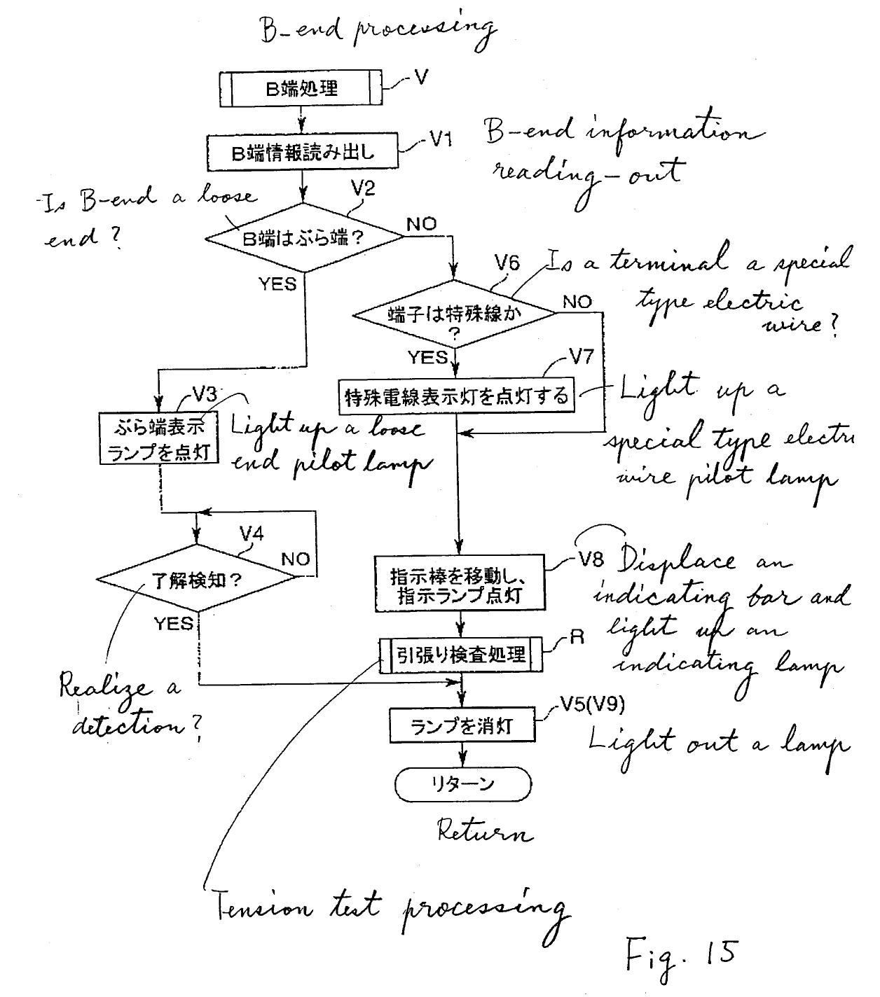

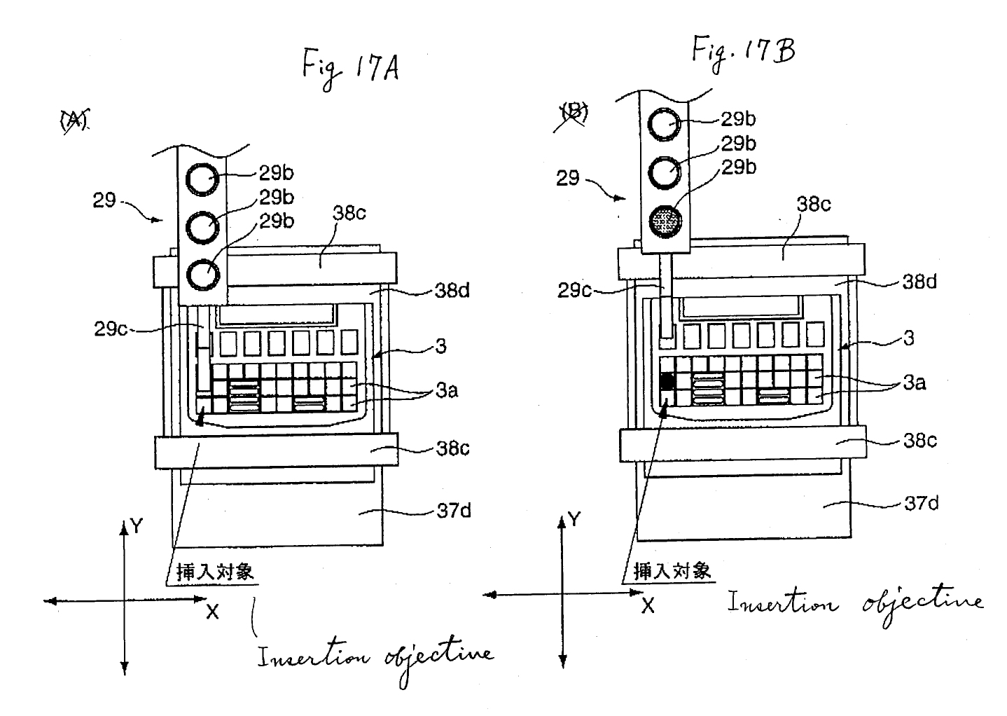

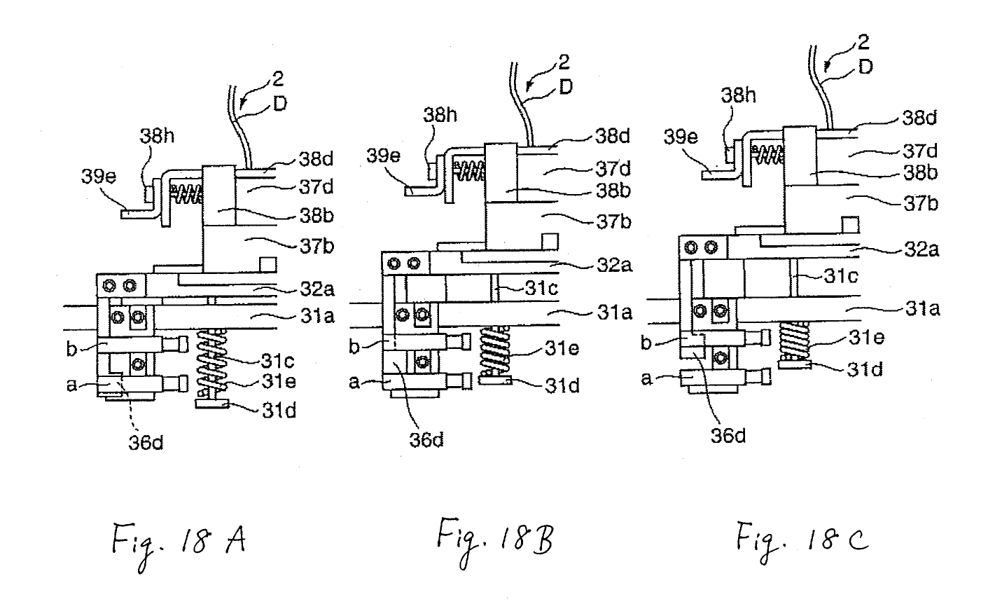

FIG. 16 is a flow chart illustrating the tension test processing R in the respective processes shown in FIGS. 14 and 15. FIG. 18A is a side elevation view of a part of the indicating apparatus 20 in the tension test processing shown in FIG. 16, illustrating the indicating apparatus 20 before carrying out the tension test processing. FIG. 18B is a side elevation view of a part of the indicating apparatus 20 in the tension test processing shown in FIG. 16, illustrating the indicating apparatus 20 before carrying out the tension test processing. FIG. 18C is a side elevation view of a part of the indicating apparatus 20 in the tension test processing shown in FIG. 16, illustrating the indicating apparatus 20 in excessive tension.

Referring to FIGS. 16 and 18, when the tension test processing R starts, the sensor “a” is waiting to be released from the shielded state (hereinafter referred to as an “OFF-state”) (step R1). This condition is shown in FIG. 18A. When an operator pulls up a cable D in the Z-direction, which is fixed to the terminal 2a inserted into the cavity 3a during an inserting operation, the shielding plate 36d of the holder adapter 32 is also pulled up to turn the sensor “a” to the OFF-state. When the sensor “a” is turned to the OFF-state, either sensor “a” or sensor “b” waits to be turned to an ON-state (steps R2 and R3). This condition is shown in FIG. 18B. The shielding plate 36d is disposed neither in the detecting groove “a1” in the sensor “a” nor in the detecting groove “b1” in the sensor “b”. Under this condition, when an operator pulls up the cable D further, the shielding plate 36d is pulled up to the position shown in FIG. 18C and the sensor “b” is turned to the ON-state. When the sensor “b” turns to the ON-state, the buzzer 56 and irregularity pilot lamp 15c are actuated to execute an excessive tension alarm (step R4). When executing the excessive tension alarm, the operating means 53 waits while an operator operates stop switches (not shown) of the buzzer 56 and irregularity pilot lamp 15c (step R5). When the stop switches are operated, it is decided whether or not another terminal 2a is inserted into the housing 3 into which the A-end and B-end are inserted (step R6). When it is decided that another terminal 2a is inserted into the housing 3, a menu “return to the start” is displayed on the displaying panel 57 and the operating means 53 waits while an answer to the menu is inputted (step R7). When an operator inputs the answer, processing of the controlling means 55 waits for to restart and the inserting operation is carried out from the first condition.

On the other hand, when it is decided that another terminal 2a is not inserted into the housing 3 in the step R6, a menu “reinsert” is displayed on the displaying panel 57 and the operating means 53 waits while an answer to the menu is inputted (step R8). When an operator inputs the answer, a processing of the controlling means 55 is advanced to the A-end processing. An operator changes the housing 3 and electric wire with terminals 2 to other ones and starts the inserting work.

In the tension test processing shown in FIG. 18, a spring constant of a tension coil spring 31e is set so that the tension coil spring 31e is in the position shown in FIG. 18B when a suitable force pulls the cable D. When a force pulls the cable to cause an irregular state in the housing 3, the tension coil spring 31e is in the position shown in FIG. 18C. Furthermore, under the condition shown in FIG. 18, the indicating bar 29 is disposed at a position (not shown) above the housing holder 37 in the Z-direction in order to indicate the insertion objective cavity 3a. When the housing holder 37 is pulled up to the position shown in FIG. 18B or 18C, a raising force is applied to the indicating bar 29 by the housing holder 37. However, the indicating bar 29 follows the raised housing holder 37 under an elastic force by the tension coil spring 30 mentioned above (FIG. 5).

In the indicating apparatus 20 constructed above, the indicating bar 29 is moved along the coordinate on the X-axis of the insertion objective cavity 3a to specify the X-direction of the cavity 3a and the proximal end of the indicating finger 29c specifies the Y-direction of the cavity 3a. In the case where another terminal 2a has been already inserted in a cavity 3a near the insertion objective cavity 3a, the indicating bar 29 is moved to the spaced position P2 to specify the X-direction of the cavity 3a. The pilot lamp 29b can specify the Y-direction of the cavity 3a.

Accordingly, even if the type of wire harness is changed, the indicating apparatus 20 can respond to the change by altering a setting of the controlling means 55. It is possible to efficiently indicate the cavity 3a near the insertion objective cavity 3a. Consequently, the indicating apparatus 20 can avoid or prevent human error.

From the above description of the invention, one skilled in the art will perceive improvements, changes and modifications. Such improvements, changes and modifications within the skill of the art are intended to be covered by the appended claims.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The entire disclosure of Japanese Patent Application No. 2002-127510 filed on Apr. 26, 2002 including the specification, claims, drawings and summary is incorporated herein by reference in its entirety.

What is claimed is:

1. An apparatus for indicating a terminal insertion position in which a terminal of an electric wire is to be inserted into a target cavity of a plurality of cavities in a connector housing, the target cavity specified by intersecting two dimensional coordinates, to produce a wire harness, wherein target cavities to receive respective terminals are successively indicated to an operator, said apparatus comprising:
a housing holder configured to hold a connector housing such that a terminal may be inserted into a target cavity;
an indicating bar provided in said apparatus to move with respect to said housing holder, said indicating bar extending along one of the coordinates of said target cavity in said housing inserted in said housing holder and indicating said one coordinate of said target cavity;
an indicator provided on said indicating bar that indicates the other coordinate of said target cavity indicated by said indicating bar;
a driving mechanism that drives said indicating bar; and
a controlling device that controls said driving mechanism and said indicator so that said indicating bar moves to a position corresponding to said one coordinate of said target cavity with said indicating bar avoiding interference with an electric wire that has been inserted and said indicator displays said other coordinate of said target cavity.

2. The apparatus for indicating a terminal insertion position according to claim 1, wherein said housing holder includes:
a housing positioning hole configured to contain said connector housing;
a regulating member provided on said housing holder configured to open and close said housing positioning hole; and
a driving member configured to displace said regulating member between an open position in which said connector housing may be inserted into or removed from said housing positioning hole and a closed position in which said connector housing is prevented from being inserted or removed from said housing positioning hole.

3. The apparatus for indicating a terminal insertion position according to claim 2, wherein said housing holder, said indicating bar, and said driving mechanism are contained within a casing, said apparatus further comprising:
a housing base provided in said casing, said housing base supporting said housing holder so that the connector housing is held by said housing holder with an end face thereof extending in a longitudinal direction.

4. The apparatus for indicating a terminal insertion position according to claim 3, said driving mechanism further comprising:
a drive screw provided in said casing and extending along said longitudinal direction;
a driving block mounted on said drive screw and connected to said indicating bar; and
an X-axis motor provided in said casing and connected to said drive screw, wherein said X-axis motor drives said indicating bar, via said drive screw and said driving block, along said longitudinal direction between cavities in the connector housing.

5. The apparatus for indicating a terminal insertion position according to claim 4, wherein said housing base supports a plurality of housing holders next to each other in said longitudinal direction and said X-axis motor drives said indicating bar along said longitudinal direction between connector housings in said housing holders.

6. The apparatus for indicating a terminal insertion position according to claim 4, said driving mechanism further comprising:
a second drive screw provided in said casing and extending along a direction transverse to said longitudinal direction;
a driving head mounted on said second drive screw and connected to said indicating bar; and
a Y-axis motor provided in said casing and connected to said second drive screw, wherein said Y-axis motor drives said indicating bar, via said second drive screw and said driving head, along said transverse direction between cavities in the connector housing.

7. The apparatus for indicating a terminal insertion position according to claim 1, wherein said indicator comprises a lamp.

8. The apparatus for indicating a terminal insertion position according to claim 7, wherein said indicator comprises a plurality of lamps corresponding to respective terminal insertion positions in said transverse direction.

9. The apparatus for indicating a terminal insertion position according to claim 6, wherein said housing base supports said housing holder so that the connector housing is held by said housing holder with an end face thereof extending in said longitudinal and said transverse directions so that a terminal may be inserted in a target cavity in a Z-axis direction perpendicular to said X-axis and said Y-axis.

10. The apparatus for indicating a terminal insertion position according to claim 6, wherein said driving head comprises:
a driving base supported by said second drive screw;
a pair of rails provided on said driving base and extending in a Z-axis direction perpendicular to said X-axis and said Y-axis; and
a coupling base provided on said indicator, said coupling base configured to slide between said pair of rails, wherein said indicator is movable in the Z-axis direction.

11. The apparatus for indicating a terminal insertion position according to claim 10, said indicator further comprising an indicating finger extending from said coupling base.

12. The apparatus for indicating a terminal insertion position according to claim 3, said apparatus further comprising:
an indicating base mounted on said casing; and
a lamp provided on said indicating base, said lamp indicating to an operator terminal insertion information.

13. The apparatus for indicating a terminal insertion position according to claim 3, wherein said casing is provided in an inclined position, facing an operator position.

14. The apparatus for indicating a terminal insertion position according to claim 6, said apparatus further comprising:
a tension testing device comprising:
a mounting plate mounted in said casing, said mounting plate including a plurality of through holes therein;
a housing holder adaptor configured to receive said housing holder and including a plurality of posts configured to couple with said through holes in said mounting plate so that said housing holder adaptor is movable relative to said mounting plate in a Z-axis direction perpendicular to said X-axis and said Y-axis; and
a sensor provided on said mounting plate and a detecting plate mounted on said housing holder adaptor for interaction with said sensor to detect movement in said Z-axis direction between said mounting plate and said housing holder adaptor;
wherein when an inserted terminal is pulled in the Z-axis direction said sensor and said detecting plate detect movement between said mounting plate and said housing holder adaptor and said controlling device indicates tension induced by the terminal pulling.

15. In combination, a wire harness producing system;
an electric wire containing unit;
a housing containing unit; and
an apparatus for indicating a terminal insertion position according to claim 1.

16. A method of indicating a terminal insertion position in which a terminal of an electric wire is to be inserted into a target cavity of a plurality of cavities in a connector housing, the target cavity specified by intersecting two dimensional coordinates, to produce a wire harness, wherein target cavities to receive respective terminals are successively indicated to an operator, said method, comprising:
holding a connector housing in a housing holder such that a terminal may be inserted into a target cavity;
moving an indicating bar with respect to said housing holder, said indicating bar extending along one of the coordinates of the target cavity in said housing inserted in said housing holder and indicating said one coordinate of the target cavity;
indicating the other coordinate of the target cavity with an indicator provided on said indicating bar;
driving said indicating bar with a driving mechanism; and
controlling said driving mechanism and said indicator so that said indicating bar moves to a position corresponding to said one coordinate of said target cavity with said indicating bar avoiding interference with an electric wire that has been inserted and said indicator displays said other coordinate of said target cavity.

17. The method of indicating a terminal insertion position according to claim 16, said method further comprising:
containing said connector housing in a housing positioning hole in said housing holder, said housing holder including a regulating member configured to open and close said housing positioning hole; and
displacing said regulating member with a driving member between an open position in which said connector housing may be inserted into or removed from said housing positioning hole and a closed position in which said connector housing is prevented from being inserted or removed from said housing positioning hole.

18. The method of indicating a terminal insertion position according to claim 17, said method further comprising:
containing said housing holder, said indicating bar, and said driving mechanism in a casing;
providing a housing base in said casing, said housing base supporting said housing holder so that the connector housing is held by said housing holder with an end face thereof extending in a longitudinal direction;
driving said indicating bar along said longitudinal direction between cavities in the connector housing to indicate a target cavity position along said longitudinal direction; and
driving said indicating bar along a direction transverse to said longitudinal direction to indicate a target cavity position along said transverse direction.

19. The method of indicating a terminal insertion position according to claim 18, wherein said indicator comprises a plurality of lamps, said method further comprising:
further indicating said target cavity position along said transverse direction via said lamps.

20. The method of indicating a terminal insertion position according to claim 18, wherein said housing base supports said housing holder so that the connector housing is held by said housing holder with an end face thereof extending in said longitudinal and said transverse directions, said method further comprising:
inserting a terminal in a target cavity in a direction perpendicular to said longitudinal and said transverse directions.
